(19) United States
(12) Patent Application Publication
(10) Pub. No.: US 2005/0238824 A1
(43) Pub. Date: Oct. 27, 2005

(54) Urethane acrylate composite structure

(75) Inventors: Joseph Ogonowski, Newport, MI (US); Calvin T. Peeler, Canton, MI (US); David D. Peters, Wyandotte, MI (US); David Kielbasa, Oak Park, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation

(21) Appl. No.: 11/088,425

(22) Filed: Mar. 24, 2005

Related U.S. Application Data
(63) Continuation-in-part of application No. 10/832,903, filed on Apr. 27, 2004.
(63) Continuation-in-part of application No. 10/935,437, filed on Sep. 7, 2004.
(63) Continuation-in-part of application No. 10/935,549, filed on Sep. 7, 2004.

(51) Int. Cl. B32B 27/04; B32B 27/40; B32B 27/06

(52) U.S. Cl. 428/31; 428/423.1; 428/337; 428/339

(57) ABSTRACT

A composite structure includes a first layer, a support layer, and a urethane acrylate layer disposed between the first layer and the support layer. The first layer is a show surface of the composite structure. The urethane acrylate layer includes a urethane acrylate composition that includes a urethane acrylate adduct. The urethane acrylate adduct is the reaction product of an isocyanate component and a stoichiometric excess of a functionalized acrylate component. The isocyanate component has at least two isocyanate groups. The functionalized acrylate component has at least one isocyanate-reactive functional group that is reactive with at least one of the isocyanate groups for forming the urethane acrylate adduct. The resulting urethane acrylate composition is sufficiently low in viscosity for many processing applications, and the urethane acrylate layer including the urethane acrylate composition exhibits sufficient adhesion to the first layer and support layer.

### RELATED APPLICATIONS

This application is a continuation-in-part of co-pending U.S. patent application Ser. Nos. 10/832,903, 10/935,437, and 10/935,549, which were filed on Apr. 27, 2004, Sep. 7, 2004, and Sep. 7, 2004, respectively.

### FIELD OF THE INVENTION

The present invention generally relates to a composite structure. The composite structure includes a urethane acrylate layer and a support layer. The composite structure is primarily utilized to replace current fiberglass reinforced polyester (FRP) composites used in the composite industry, including transportation, bathware, and marine applications.

### BACKGROUND OF THE INVENTION

Use of composite structures is known in the art, as are composite structures including a first layer and a support layer including a continuous phase and fiber for reinforcement. The first layer, also referred to as a show or wear surface, is typically, but not always, a paint or a styrenated polyester gel coat; however, acrylic polymers, styrenated polyester, and styrenic copolymers have also been included in such show surfaces for the composite structures. Methods of forming the show surface are also known, such as spraying the paint onto a barrier coat and forming the composite structure behind a pre-formed show surface.

Typically, the continuous phase is formed from either a fiberglass reinforced polyester (FRP) or a reinforced polyurethane. The support layer functions to provide structural integrity and durability to the complete composite structure and can be made up of multiple layers of the continuous phase encapsulating reinforcing materials, such as fiberglass, wood, metal, cardboard, etc.

Urethane acrylate compositions have also been developed for limited use in the continuous phase for the support layer of the composite structures. The urethane acrylate compositions are the reaction product of an isocyanate component and a functionalized acrylate component that is reactive with the isocyanate component. The urethane acrylate compositions are less sensitive to moisture, as compared to the composite structures including the polyurethane-based continuous phase. However, the urethane acrylate compositions of the prior art are not suitable for use in many composite structure applications because of resin stability limitations, reactivity concerns, and cost. Furthermore, these urethane acrylate compositions are not optimized for gel time, adhesion between the layers, and viscosity for enabling spray application.

For example, U.S. Pat. No. 6,509,086 discloses a composite structure having a show surface and a support layer. The show surface is formed from an acrylic polymer and may be formed through a thermoforming process. The support layer is formed from a composition that includes up to 50 parts by weight of urethane acrylate, based on the total weight of the composition. The composition is applied to the back side of the show surface while the show surface is in the mold. The urethane acrylate is the reaction product of isophorone diisocyanate, i.e., the isocyanate component, and a stoichiometric amount of 2-hydroxyethyl methacrylate (HEMA), i.e., the functionalized acrylate component. The '086 patent does not disclose other compositions for the show surface besides the acrylic polymer and the components in the support layer are not optimized to maximize adhesion between the layer. Furthermore, the composition is not optimized for desirable gel times. As a result, other compositions of the first layer may not sufficiently adhere to the urethane acrylate disclosed in the '086 patent.

A barrier coat has also been disclosed for providing a desired surface for receiving the paint to form the first layer. The barrier coat is useful since the support layer typically includes the fiber, which may protrude from the support layer and translate to a rough appearance of the show surface in the absence of a barrier coat. This is especially apparent when the show surface is formed from paint through a post-demolding painting process. Such barrier coats are commonly formed from non-fiberglass-reinforced polyester or other materials, such as poly-dicyclopentadiene.

When barrier coats are used, large quantities of styrene monomers, other monomeric components, and other volatile organic compounds (VOC) are emitted, which is undesirable. As a result of the quantities of VOCs associated with the composite structures of the prior art, the Environmental Protection Agency (EPA) is placing restrictions on the composite industry to reduce or eliminate the emissions.

PCT Publication No. WO200130879 discloses a urethane acrylate composition for forming the barrier coat of a composite structure; however, the urethane acrylate composition, like the urethane acrylate compositions proposed for the continuous phase of the support layer, are not optimized for gel time, adhesion between the layers, and viscosity for enabling spray application. Furthermore, the barrier coat formed from the urethane acrylate composition was proposed for use with conventional polymers used in the composite industry, such as polyester, in the continuous phase of the support layer. Such conventional polymers are deficient in many aspects of their performance and those based on the typical two component polyurethane are sensitive to moisture and prone to performance and physical property defects due to the presence of and reaction with moisture.

Due to the deficiencies of the prior art, including those described above, it is desirable to provide a unique composite structure having a support layer including a continuous phase and fiber and a urethane acrylate layer formed from a urethane acrylate composition that is optimized for gel time, adhesion between the layers, and viscosity for enabling spray application of the urethane acrylate composition to form the barrier coat.

### SUMMARY OF THE INVENTION AND ADVANTAGES

The subject invention provides a composite structure. The composite structure includes a urethane acrylate layer and a support layer. The urethane acrylate layer is formed from a urethane acrylate composition including a urethane acrylate adduct. The urethane acrylate adduct is the reaction product of an isocyanate component and a stoichiometric excess of a functionalized acrylate component. The isocyanate component has at least two isocyanate groups, and the functionalized acrylate component has at least one isocyanate-reactive functional group that is reactive with at least one of the isocyanate groups.

The urethane acrylate composition has an intrinsically low viscosity, which is responsible in part for lower VOC emissions than typical styrenated polyester or vinyl ester resins. More specifically, the urethane acrylate composition has a sufficiently low viscosity to allow for many processing applications of the urethane acrylate composition without any additional reactive diluents, which the prior art compositions require and which result in higher VOC emissions. Furthermore, the urethane acrylate adduct is not reactive with water, unlike the polyurethane-based support layer described in prior art compositions and is therefore not subject to the physical property deficiency resulting from the reaction with moisture during spray applications. This results in more consistent physical properties of the urethane acrylate layer in the composite structure. Further, depending on a chemical composition of the support layer, the urethane acrylate adduct may react with the support layer to yield a stronger cohesive or adhesive bond without the use of adhesion promoters, as is required in the prior art composite structures. The urethane acrylate composition of the subject invention is also optimized to provide sufficient time to form the support layer on the urethane acrylate layer before the urethane acrylate layer completely gels.

### DETAILED DESCRIPTION OF A PREFERRED EMBODIMENT

A composite structure according to the subject invention includes a urethane acrylate layer and a support layer. The urethane acrylate layer is formed from a urethane acrylate composition. In one embodiment, the urethane acrylate layer is a show surface of the composite structure. In another embodiment, the composite structure further includes a first layer that is the show surface of the composite structure, and the urethane acrylate layer functions as a barrier coat that is disposed between the first layer and the support layer.

Preferably, the urethane acrylate layer and the support layer are formed on a mold substrate in an open-mold process to form the composite structure. However, it is to be appreciated that the urethane acrylate composite structure may be formed in a closed mold process or via a combination of open and closed mold processing steps. Preferably, a surface of the mold substrate is coated with a known mold release agent to facilitate the eventual removing of the composite structure. By way of a non-limiting example, the mold release agent may be a composition including silicones, soaps, waxes and/or solvents.

For the open-mold process, the urethane acrylate composition is applied to the surface of the mold substrate to form the urethane acrylate layer over the mold release agent on the surface of the mold substrate. Optionally, when the first layer is present, the first layer may be formed on the surface of the mold substrate over the mold release agent, and the urethane acrylate layer may be formed over the first layer. Alternatively, the first layer may be formed on the urethane acrylate layer subsequent to demolding the urethane acrylate layer from the mold substrate such as in a post-production painting process.

Preferably, the first layer is formed from a paint for enhancing the appearance of the composite structure. It is to be understood that the paint may be any paint as known in the art for forming the first layer, and may include any pigment known in the art, such as titanium dioxide. Examples of paint suitable for the subject invention include paint selected from the group of latex-based waterborne paints, latex-based solventborne paints, acrylic-based waterborne paints, acrylic-based solventborne paints, polyurethane-based waterborne paints, polyurethane-based solventborne paints, and combinations thereof.

The urethane acrylate composition has sufficiently low viscosity to enable spraying of the urethane acrylate composition during production of the composite structure. It is to be appreciated that the urethane acrylate composition may be poured or injected; however, spraying is preferred for production of certain composite structures. Once formed, the urethane acrylate layer is preferably cured at room temperature of about 77° F. for a length of time sufficient to prevent bleeding and read through, but not so long as to prevent bonding to the support layer. Typically, the urethane acrylate layer is cured until the material has gelled and, depending on a catalyst system used, the curing time may vary from 5 to about 60 minutes. The rate of reaction may be tailored to the specific needs for the production of the composite structure. The support layer is then formed on the urethane acrylate layer. In one embodiment, fiber is chopped from a feed supply and introduced into the support layer as the support layer is formed. Preferably, the support layer with the fiber is rolled to eliminate entrained and otherwise trapped air resulting in a layer of densified material. In another embodiment, the support layer without fiber is formed thinly on the urethane acrylate layer. The fiber is then applied onto the support layer. The support layer including the fiber is then rolled before curing is complete to ensure lamination of the fiber into the support layer and the composite structure is allowed to cure before it is removed from the mold substrate.

The urethane acrylate composition of the urethane acrylate layer includes a urethane acrylate adduct, which is the reaction product of an isocyanate component and a functionalized acrylate component that is reactive with the isocyanate component. More specifically, the isocyanate component has at least two isocyanate groups, which provide polymeric functionality to the urethane acrylate adduct, and the functionalized acrylate component has at least one isocyanate-reactive functional group that is reactive with at least one of the isocyanate groups. In a preferred embodiment, the isocyanate component has from two to three isocyanate groups.

Depending on the intended use of the composite structure, the isocyanate component of the urethane acrylate adduct preferably includes an aliphatic isocyanate and/or a modified aliphatic isocyanate. For example, for composite structures that are exposed to direct sunlight, UV stability is critical, especially when UV transparent additives, such as titanium dioxide pigment, are utilized. Urethane acrylate adducts that are the reaction product of the aliphatic isocyanate and the functionalized acrylate component are more stable to UV light than urethane acrylate adducts that are the reaction product of an aromatic isocyanate. In other words, for the composite structures that are exposed to direct sunlight or other sources of UV light, wherein the first layer is absent or transmits the UV light, the isocyanate component may also include aromatic isocyanates so long as at least one UV inhibitor is included in the urethane acrylate composition such that the urethane acrylate layer is acceptably stable under exposure to UV light. Such UV inhibitors are known in the art. For composite structures where UV stability is not critical, aliphatic isocyanates are not required. Suitable isocyanates for the isocyanate component, both aromatic and aliphatic, are described below in significant detail in terms of the support layer. Whenever the term aliphatic is used throughout the subject application, it is intended to indicate any combination of aliphatic, acyclic, and cyclic arrangements or otherwise modified structures. That is, aliphatic indicates both straight chains and branched arrangements of carbon atoms (non-cyclic) as well as arrangements of carbon atoms in closed ring structures (cyclic) so long as these arrangements are not aromatic.

Specific aliphatic isocyanate components that may be suitable for the urethane acrylate adduct include, but are not limited to, hexamethylene diisocyanate (HDI), hexamethylene diisocyanate trimer (HDI Trimer), hexamethylene diisocyanate biuret (HDI Biuret), meta-tetramethylxylene diisocyanate (TMXDI), and combinations thereof. Cycloaliphatic diisocyanates are also suitable, such as, but are not limited to, cyclohexane diisocyanate including dicyclohexane-4,4′-diisocyanate and 1,3- and 1,4-cyclohexane diisocyanate as well as any combinations of these isomers, 1-isocyanato-3,3,5-trimethyl-5-isocyanatomethylcyclohexane (isophorone diisocyanate), isophorone diisocyanate trimer (IPDI Trimer), 2,4- and 2,6-hexahydrotoluene diisocyanate as well as the corresponding isomeric mixtures, 4,4′- 2,2′-, and 2,4′-dicyclohexylmethane diisocyanate as well as the corresponding isomeric mixtures. Other isocyanate components are also suitable, such as aromatic isocyanates, in combination with a UV inhibitor to prevent degradation of the urethane acrylate adduct formed therefrom.

As discussed in detail above, when the first layer is present, the isocyanate component of the urethane acrylate composition may include any of the aforementioned aliphatic isocyanates, in addition to araliphatic isocyanate, aromatic isocyanate, or any combination thereof. The aromatic isocyanate may be selected from the group of toluene diisocyanates, polymeric diphenylmethane diisocyanates, diphenylmethane diisocyanates, and combinations thereof. Specific examples of preferred isocyanate components suitable for the urethane acrylate adduct include, but are not limited to, aromatic diisocyanates such as 2,4- and 2,6-toluene diisocyanate and the corresponding isomeric mixtures, and 4,4′-, 2,4′-, and 2,2′-diphenylmethane diisocyanate and the corresponding isomeric mixtures. The aforementioned aromatic isocyanates are available in commercial form as Lupranate® M20S Isocyanate, Lupranate® MI Isocyanate, Lupranate® M70R Isocyanate, Lupranate® M200 Isocyanate, ELASTOFLEX® R23000 Isocyanate, and Lupranate® T-80 Isocyanate. All are commercially available from BASF Corporation of Wyandotte, Mich. As alluded to above, the isocyanate component may include a combination of isocyanates. That is, a blend of at least two isocyanates may be utilized for reaction with the functionalized acrylate component to form the urethane acrylate adduct.

Specific examples of other isocyanates that are suitable for the isocyanate component of the urethane acrylate adduct include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate, as well as combinations of any of the aforementioned isocyanate components.

Additionally, it is to be understood that the isocyanate component may be an isocyanate terminated quazi-prepolymer or otherwise modified isocyanate prepared from the aforementioned isocyanates or combinations of isocyanates. More specifically, the isocyanate component may include any of the aforementioned isocyanates and a stoichiometrically insufficient amount of a polyhydroxyl compound such as, but not limited to, polyether polyol and/or polyester-based polyols, polyhydroxy olefinic, or acrylate-substituted species. Further, the polyhydroxy olefinic or acrylate-substituted species of these prepolymers may include at least one isocyanate-reactive functional group that is reactive with the isocyanate component and at least one reactive acrylate or olefinic group. The prepolymer may then be further reacted with the functionalized acrylate component to fully react all remaining free isocyanate groups of the prepolymer described above to form the urethane acrylate adduct.

As set forth above, the functionalized acrylate component used to form the urethane acrylate layer has at least one isocyanate-reactive functional group that is reactive with at least one of the isocyanate groups. Preferably, the functionalized acrylate component has from one to four isocyanate-reactive functional groups. In a most preferred embodiment, the functionalized acrylate component has one isocyanate-reactive functional group which, when reacted with the isocyanate component, provides sufficiently low viscosity to enable processing of the urethane acrylate composition during the production of the composite structure. The sufficiently low viscosity will be discussed in further detail below.

Preferably, the isocyanate-reactive functional groups are selected from the group of hydroxy-functional groups, amine-functional groups, and combinations thereof. Suitable hydroxy-functional groups also include an alkyl portion having from one to twenty carbon atoms. Specific examples of functionalized acrylate components including suitable hydroxy-functional groups include, but are not limited to, hydroxymethyl, hydroxyethyl, hydroxypropyl, and hydroxybutyl acrylates and alkacrylates, and combinations thereof. It is to be appreciated that the functionalized acrylate component may include more than one of the aforementioned hydroxy-functional groups and may be incorporated as a prepolymer as described above.

Preferably, the functional group of the functionalized acrylate component has at least one alkyl group with from one to twenty carbon atoms. Specific examples of functionalized acrylate components including suitable alkyl groups include, but are not limited to, methacrylates, ethacrylates, propacrylates, butacrylates, phenylacrylates, methacrylamides, ethacrylamides, butacrylamides, and combinations thereof. Preferred functionalized acrylate components include hydroxymethyl methacrylate, hydroxyethyl methacrylate, hydroxypropyl methacrylate, hydroxym ethyl ethacrylate, hydroxyethyl ethacrylate, hydroxypropyl ethacrylate, glycerol dimethacrylate, N-methylol methacrylamide, 2-tert-butyl aminoethyl methacrylate, dimethylaminopropyl methacrylamide, and combinations thereof. Further, it is to be appreciated that the functionalized acrylate component may include substituted acrylates such as, but not limited to, hydroxyethyl acrylate and hydroxymethyl acrylate.

As stated above, the functionalized acrylate component is provided in a stoichiometric excess with respect to the isocyanate component. The excess functionalized acrylate component functions as a reactive diluent, which lowers the viscosity of the urethane acrylate composition and cross-links with the urethane acrylate adduct during formation of the urethane acrylate layer. Preferably, the stoichiometric excess of the functionalized acrylate component is defined as a molar equivalent ratio of the functionalized acrylate component to the isocyanate component ranging from 3:1 to 1.05:1. More preferably, the stoichiometric excess is defined as a molar equivalent ratio ranging from 2.5:1 to 1.05:1. In a most preferred embodiment, the stoichiometric excess is defined as a molar equivalent ratio of the functionalized acrylate component to the isocyanate component ranging from 2:1 to 1.05:1. The actual amounts by weight of the functionalized acrylate component and the isocyanate component will vary depending on the specific composition of the functionalized acrylate component used, as well as with the specific isocyanate component used. Further, the choice of the specific isocyanate and acrylate components will affect the resultant viscosity of the urethane acrylate composition.

In one embodiment, as alluded to above, the urethane acrylate composition further includes the catalyst system. Generally, the catalyst system catalyzes a free radical reaction of the urethane acrylate composition, and allows the urethane acrylate composition to cure at room temperature within a short period of time. More specifically, it catalyzes the free radical reaction of an unsaturated functionality of the urethane acrylate adduct with another unsaturated functionality of the urethane acrylate adduct and/or of the reactive diluent to form the urethane acrylate layer. It is contemplated that the reactive diluent includes the excess functionalized acrylate component, among other reactive diluents that may be present and that are discussed in further detail below.

The catalyst system includes a peroxide-based catalyst. Without intending to be bound or limited by any particular theory, it is believed that the peroxide-based catalyst serves as a source of free radicals through an interaction with an accelerator, to be described in further detail below. The free radicals generated allow polymerization to occur via a free-radical polymerization mechanism. Preferably the peroxide-based catalyst includes, but is not limited to, an organic peroxide. Specific examples of suitable peroxide-based catalysts include, but are not limited to, dibenzoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumene hydroperoxide, paramenthane hydroperoxide, diacetyl peroxide, di-alpha-cumyl peroxide, dipropyl peroxide, diisopropyl peroxide, isopropyl-t-butyl peroxide, butyl-t-butyl peroxide, difuroyl peroxide, bis (triphenylmethyl) peroxide, bis(p-methoxybenzoyl)peroxide, p-monomethoxybenzoyl peroxide, rubene peroxide, propyl hydroperoxide, isopropyl hydroperoxide, n-butyl hydroperoxide, t-butyl hydroperoxide, cyclohexyl hydroperoxide, trans-decalin hydroperoxide, alpha-methylbenzyl hydroperoxide, alpha-methyl-alpha-ethyl benzyl hydroperoxide, tetralin hydroperoxide, triphenylmethyl hydroperoxide, diphenylmethyl hydroperoxide, benzoyl peroxide, and combinations thereof. In addition, photo-initiated and azo-based catalysts may also be suitable.

The catalyst system also includes a first metal salt. Without intending to be bound or limited by any particular theory, it is believed that the first metal salt interacts with a second metal salt, to be described in further detail below, and aids in an oxidative surface curing of the urethane acrylate composition. Preferably, the first metal salt includes, but is not limited to, a metal carboxylate. However, other metal salts that are not metal carboxylates are also contemplated for use herein. One example of another metal salt that is not a metal carboxylate is cobalt naphthenate. More preferably, the first metal salt includes an oxidizable transition metal carboxylate. Most preferably, the first metal salt includes cobalt carboxylate and is commercially available from OM Group Inc. of Cleveland, Ohio, under the trade name of 12% Cobalt Cem-All®. Preferably, the first metal salt is present in an amount of from 0.01 to 1.00, more preferably of from 0.05 to 0.75, and most preferably of from 0.10 to 0.50 parts by weight based on 100 parts by weight of the urethane acrylate composition.

Preferably, as set forth above, the catalyst system also includes the second metal salt. The second metal salt promotes a surface curing of the support layer in the final composite structure. Without intending to be bound or limited by any particular theory, it is believed that the second metal salt interacts with the first metal salt to help promote a ligand exchange or a formation of a coordination complex in oxidative curing of the first metal salt. Preferably, the second metal salt includes, but is not limited to, a metal carboxylate. Most preferably, the second metal salt includes potassium octoate and is commercially available from Air Products and Chemicals, Inc. of Allentown, Pa. under the trade name of DABCO® K-15. Preferably, the second metal salt is present in an amount of from 0.010 to 1.000, more preferably of from 0.025 to 0.500, and most preferably of from 0.050 to 0.250 parts by weight based on 100 parts by weight of the urethane acrylate composition.

Preferably, as set forth above, the catalyst system also includes the accelerator. Without intending to be bound or limited by any particular theory, it is believed that the accelerator forms a coordination complex with the first and second metal salt to increase a rate of peroxide decomposition, thus accelerating the free radical polymerization cross-linking in the urethane acrylate composition. Preferably, the accelerator is selected from the group of, but is not limited to, anilines, amines, amides, pyridines, and combinations thereof. However, other accelerators, such as acetylacetone, have also been contemplated for use in the subject invention. More preferably, the accelerator includes a dimethyl toluidine or a dialkyl aniline. Most preferably, the accelerator includes N,N-dimethyl-p-toluidine, N,N-diethylaniline, N,N-dimethylaniline, and combinations thereof to optimize the curing of the urethane acrylate layer depending on the selection of the peroxide. The most preferred accelerator is selected based on a desired gel time. N,N-dimethyl-p-toluidine is selected for fast gel times of less than 5 minutes. N,N-diethylaniline and N,N-dimethylaniline are selected for slower gel times of greater than 5 minutes. Preferably, the accelerator is present in an amount of from 0.01 to 0.50, more preferably of from 0.05 to 0.40, and most preferably of from 0.08 to 0.30 parts by weight based on 100 parts by weight of the urethane acrylate composition.

Depending on the selection of the peroxide-based catalyst, heat or other promotion techniques may also be required to promote and accelerate the initiation of the reaction. It is to be appreciated that other materials that function in combination with the above-mentioned metal salts and accelerators may also be used in the catalyst system.

Preferably, the total amount of the catalyst system present in the composition is from 0.02 to 7 parts by weight, more preferably from 0.5 to 5 parts by weight, based on the total weight of the urethane acrylate composition.

Optionally, an additional reactive diluent may also be included in the urethane acrylate composition to further lower the viscosity of the urethane acrylate composition and/or modify the physical properties of the final composite structure. The reactive diluent has at least one acrylate-reactive functional group selected from, but not limited to, the group of vinyl, allyl, cyclic allyl, cyclic vinyl, acrylic, functionalized acrylic, acrylamides, acrylonitrile, and combinations thereof. Specific examples of reactive diluents that are suitable for the subject invention include, but are not limited to styrene, divinyl benzene, allyl alkylacrylates, vinyl toluene, diacetone acrylamide, acrylonitrile, methyl methacrylate, hydroxyethyl methacrylate, hydroxypropyl methacrylate, alpha methyl styrene, butyl styrene, monochlorostyrene, and combinations thereof. Preferably, the weight ratio of the reactive diluent to the urethane acrylate adduct is at least 0.01:1. More preferably, the weight ratio of the reactive diluent to the functionalized acrylate component is from 0.1:1 to 1:1. In terms of actual amounts by weight, the reactive diluent is preferably present in an amount of at least 1.0 part by weight, more preferably from 1.0 to 50 parts by weight, most preferably from 5 to 40 parts by weight based on the total weight of the urethane acrylate composition.

Fillers may also be included in the urethane acrylate layer. The filler in the urethane acrylate layer may provide pigmentation, flame retardance, insulation, aid with dimensional stability and physical properties, and reduced cost of the composite structure. Suitable fillers for the urethane acrylate layer include reactive and non-reactive conventional organic and inorganic fillers. More specific examples include, but are not limited to, inorganic fillers, such as silicate minerals, for example, both hollow and solid glass beads, phyllosilicates such as antigorite, serpentine, hornblends, amphiboles, chrysotile, and talc; metal oxides, such as aluminum oxides, titanium oxides and iron oxides; metal salts, such as chalk, barite and inorganic pigments, such as cadmium sulfide, zinc sulfide and glass, inter alia; kaolin (china clay), and aluminum silicate and co-precipitates of barium sulfate and aluminum silicate. Examples of suitable organic fillers include, but are not limited to, carbon black and melamine. In a preferred embodiment, the filler is calcium carbonate.

The inorganic and organic fillers may be used individually or as mixtures and are blended into the urethane acrylate composition in amounts of less than or equal to 75 parts by weight, more preferably less than or equal to 55 parts by weight, most preferably from 30 to 45 parts by weight, based on the total weight of the urethane acrylate layer.

The urethane acrylate layer may further include an additive or a combination of additives. If included, the additive is selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, gel time retarders, and combinations thereof. Other suitable additives include, but are not limited to, hydrolysis-protection agents, fungistatic and bacteriostatic substances, dispersing agents, adhesion promoters, and appearance enhancing agents such as flow and wetting agents, pigments, and dyes. Each of these additives serves a specific function, or functions, within the urethane acrylate layer that are known to those skilled in the art.

The viscosity of the urethane acrylate composition including the urethane acrylate adduct, the reactive diluent, the catalyst system, and other additives where applicable, must be sufficiently low to enable spray application during the production of the composite structure. The viscosity of the urethane acrylate composition is from 800 to 55000 centipoise at 77° F., as measured on a Brookfield® RVT viscometer at 10 rpm, and a thixotropic index is from 2.4 to 10. Preferably, the urethane acrylate composition, absent fillers, has a viscosity of from 50 to 3000 centipoise, more preferably from 100 to 300 centipoise, most preferably from 150 to 250 centipoise, at 77° F. Lower viscosities within the above-stated ranges are required as the amount of filler present in the composition is increased.

The urethane acrylate layer provides a desired surface that is suitable for adhering to the first layer, and is also suitable for functioning as the show surface of the composite structure. The urethane acrylate layer preferably has a thickness of from 0.005 to 0.050 inches thick, more preferably from 0.01 to 0.04 inches to sufficiently cover the support layer. The urethane acrylate layer has improved properties such as, but not limited to, minimal shrinkage and porosity, maximized impact resistance, and wetting and de-aeration for improving adhesion to the first layer, when the first layer is present. It is to be appreciated that the thickness of the urethane acrylate layer may vary depending on the presence of the additional reactive diluents, which may enhance the adhesion between the layers.

Generally, the support layer comprises a continuous phase and fiber. In one embodiment, the continuous phase may comprise conventional materials, such as unsaturated polyester. In another embodiment, the continuous phase comprises a second urethane acrylate composition. The second urethane acrylate composition includes a second urethane acrylate adduct that is the reaction product of a second isocyanate component and a second functionalized acrylate component. Any of the aforementioned isocyanates and functionalized acrylates are suitable for the second urethane acrylate adduct. Thus, the second urethane acrylate adduct may be the same as the urethane acrylate adduct of the urethane acrylate layer; however, the urethane acrylate layer and, optionally, the first layer block UV light from degrading the second urethane acrylate composition. As such, both of the second isocyanate component and the second functionalized acrylate component may be different from the components used to form the urethane acrylate adduct. For example, for the urethane acrylate layer that is the show surface of the composite structure, i.e., in the absence of the first layer, the isocyanate component may be an aliphatic isocyanate. For the support layer backing the urethane acrylate layer, the second urethane acrylate adduct may be the reaction product of an aromatic isocyanate, since the support layer is not subject to degradation due to UV light.

Preferably, fibers are included in the support layer to reinforce the composite structure, to minimize or eliminate crack propagation, and to provide structural integrity to the composite structure. If included, the fibers include, but are not limited to, chopped fiberglass, chopped carbon fibers, chopped wood fibers, chopped aramid fibers including all aromatic polyamide materials, chopped polymer fibers such as nylon, cellulose fibers, polyacrylonitrile fibers, polyurethane fibers, and polyester fibers based on aromatic and/or aliphatic dicarboxylic acid esters, and in particular, carbon fibers, and combinations thereof. In a most preferred embodiment, the fiber is chopped glass. However, it is to be appreciated that the composite structure may be produced without the fiber, given that the non-reinforced composite structure yields the desired physical and functional properties.

In addition to fiber, other fillers and additives may be included in the support layer. Such fillers and additives are all set forth above. The support layer preferably has a thickness of from 0.125 to 1 inches.

The first layer, urethane acrylate layer, and support layer exhibit sufficient adhesion for transportation, bathware, and marine applications, as measured through humidity and abrasion-resistance tests, which are described in further detail in the Examples below.

The following examples, illustrating the composition of the first layer and the support layer, are intended to illustrate and not to limit the invention. The amounts set forth in these examples are by weight, unless otherwise indicated.

### EXAMPLES

Composite structures of the subject invention are formed including the first layer and the urethane acrylate layer. The first layer is formed from a paint indicated below in Table 1. The paint is applied to the urethane acrylate layer through a post demolding painting process. The urethane acrylate layer is formed from a urethane acrylate composition including the urethane acrylate adduct, among other components that are set forth below in Table 1. Viscosity of the urethane acrylate composition including the urethane acrylate adduct and other components is measured at 77° F. with a Brookfield® RVT viscometer, both at 10 rpm and 100 rpm to determine the thixotropic index of the composition. The composite structure is prepared by spraying the urethane acrylate composition onto the surface of the mold substrate. The urethane acrylate composition is removed from the mold; however, it is to be appreciated that the second urethane acrylate composition may be applied to the urethane acrylate layer on the mold substrate to form the support layer. The first layer is then formed on the urethane acrylate layer. More specifically, a surface of the urethane acrylate layer is scuffed with 400 grit sandpaper. The surface is then cleaned with RM902 plastic cleaner, a hydrocarbon-based cleaner available from BASF Corporation. A base coat is applied to the urethane acrylate layer and allowed to dry. A clearcoat is applied to the base coat to complete the first layer.

Adhesion between the first layer and the urethane acrylate layer is measured by subjecting the composite structures to a humidity test and a gravel test for testing abrasion resistance. For the humidity test, ASTM method 2247-87, or GM-4465P are used. Specifically, the composite structure is maintained in a chamber at 100° F. at a humidity of 100% for a period of 96 hours. For the gravel test, ASTM method D3170-87 or GM9508P are used. The results of the humidity and gravel tests are shown in Table 1 below and indicate the quality of adhesion between the first layer and the urethane acrylate layer.

Specific components included in the first layer and the urethane acrylate layer, along with the viscosity of the urethane acrylate composition including the urethane acrylate adduct prior to reaction, are set forth in Table 1. All amounts are in parts by weight based on the total weight of the respective layer unless otherwise noted.

TABLE 1

| | Component | Ex. A | Ex. B | Ex. C | Ex. D |
|---|---|---|---|---|---|
| First Layer | Base Coat, mils | 0.5-1.5 | 0.5-1.5 | 0.5-1.5 | 0.5-1.5 |
| | Clear Coat, mils | 1.8-2.2 | 1.8-2.2 | 1.8-2.2 | 1.8-2.2 |
| Urethane | Urethane Acrylate Adduct | 33.48 | 33.48 | 33.48 | 47.84 |
| Acrylate | Reactive Diluent | 5.91 | 5.91 | 5.91 | 0.00 |
| Layer | Peroxide-based Catalyst A | 0.40 | 0.40 | 0.40 | 0.00 |
| | Peroxide-based Catalyst B | 0.00 | 0.00 | 0.00 | 1.68 |
| | First Metal Salt | 0.18 | 0.18 | 0.18 | 0.29 |
| | Second Metal Salt | 0.05 | 0.05 | 0.05 | 0.14 |
| | Accelerator | 0.06 | 0.06 | 0.06 | 0.00 |
| | Additive A | 0.40 | 0.40 | 0.40 | 0.00 |
| | Additive B | 40.25 | 40.25 | 40.25 | 33.61 |
| | Additive C | 1.23 | 1.23 | 1.23 | 0.00 |
| | Additive D | 18.03 | 18.03 | 18.03 | 15.97 |
| | Additive E | 0.00 | 0.00 | 0.00 | 0.22 |
| | Additive F | 0.00 | 0.00 | 0.00 | 0.24 |
| | Viscosity, Cps at 10 rpm | 6600 | 6600 | 6600 | N/A |
| | Viscosity, Cps at 100 rpm | 1930 | 1930 | 1930 | N/A |
| | Gel Time, Minutes | 7:42 | 7:42 | 7:42 | N/A |
| | Thickness, inches | 0.125 | 0.125 | 0.125 | 0.098 |
| | Humidity Testing | Passed | Passed | Passed | Passed |
| | Abrasion Resistance | Passed | Passed | Passed | Passed |
| | Testing | | | | |

Base Coat is Diamont® Basecoat, commercially available from BASF Corporation.

Clear Coat is Diamont® Clear Coat, commercially available from BASF Corporation.

Urethane Acrylate Adduct is prepared from the reaction of a polymeric diphenylmethane diisocyanate (PMDI) having an actual functionality of about 2.7 and an NCO content of about 31.4 parts by weight based on the total weight of the PMDI and one reactive equivalent of isocyanate, commercially available from BASF Corporation of Wyandotte, Mich., and 98% hydroxyethyl methacrylate (HEMA) having two reactive equivalents of hydroxyl groups, commercially available from Degussa.

Reactive Diluent is methyl methacrylate.

Peroxide-based Catalyst A is a 40% benzoyl peroxide solution.

Peroxide-based Catalyst B is cumene hydroperoxide commercially available from Witco.

First Metal Salt is a 12% cobalt solution, commercially available from OMG Americas, Inc.

Second Metal Salt is a 75% solution of potassium octoate commercially available from Air Products and Chemicals, Inc.

Accelerator is N,N-dimethyl-para-toluidine (DMPT), commercially available from RSA.

Additive A is a silicone-based anti-foam agent commercially available from Byk-Chemie.

Additive B is calcium carbonate commercially available from Omya Corporation.

Additive C is 2,2,4-trimethyl-1,3-pentanediol diisobutyrate plasticizer commercially available from Eastman-Kodak.

Additive D is chopped glass having a ½ inch average length, commercially available from Owens-Corning.

Additive E is another silicone-based anti-foam agent commercially available from Byk-Chemie.

Additive F is a fumed silica thixotropic agent.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A composite structure comprising:
A) a urethane acrylate layer formed from a urethane acrylate composition comprising:
I) a urethane acrylate adduct comprising the reaction product of:
a) a isocyanate component having at least two isocyanate groups; and
b) a stoichiometric excess of a functionalized acrylate component having at least one isocyanate-reactive functional group; and
II) a catalyst system comprising:
a) a peroxide-based catalyst; and
b) a first metal salt; and
B) a support layer comprising a continuous phase and fiber.

2. A composite structure as set forth in claim 1 wherein said isocyanate component comprises an aliphatic isocyanate.

3. A composite structure as set forth in claim 2 wherein said aliphatic isocyanate is selected from the group of hexamethylene diisocyanate, hexamethylene diisocyanate trimer, hexamethylene diisocyanate biuret, cyclohexane diisocyanate, isophorone diisocyanate, isophorone diisocyanate trimer, dicyclohexane-4,4′diisocyanate, meta-tetramethylxylene diisocyanate, and combinations thereof.

4. A composite structure as set forth in claim 1 wherein said isocyanate component comprises an aromatic isocyanate.

5. A composite structure as set forth in claim 4 wherein said aromatic isocyanate is selected from the group of toluene diisocyanates, polymeric diphenylmethane diisocyanates, diphenylmethane diisocyanates, and combinations thereof.

6. A composite structure as set forth in claim 4 wherein said urethane acrylate composition further comprises a UV inhibitor.

7. A composite structure as set forth in claim 1 wherein said continuous phase comprises unsaturated polyester.

8. A composite structure as set forth in claim 1 wherein said continuous phase comprises a second urethane acrylate composition.

9. A composite structure as set forth in claim 8 wherein said second urethane acrylate composition is the same as said urethane acrylate composition.

10. A composite structure as set forth in claim 8 wherein said second urethane acrylate composition comprises a second urethane acrylate adduct comprising the reaction product of a second isocyanate component different from said isocyanate component and a second functionalized acrylate component.

11. A composite structure as set forth in claim 10 wherein said second isocyanate component comprises an aromatic isocyanate selected from the group of toluene diisocyanates, polymeric diphenylmethane diisocyanates, diphenylmethane diisocyanates, and combinations thereof.

12. A composite structure as set forth in claim 1 further comprising a first layer that is a show surface of said composite structure.

13. A composite structure as set forth in claim 12 wherein said first layer is disposed adjacent to said urethane acrylate layer.

14. A composite structure as set forth in claim 12 wherein said first layer comprises a paint selected from the group of latex-based waterborne paints, latex-based solventborne paints, acrylic-based waterborne paints, acrylic-based solventborne paints, polyurethane-based waterborne paints, polyurethane-based solventborne paints, and combinations thereof.

15. A composite structure as set forth in claim 14 wherein said urethane acrylate composition further comprises a UV inhibitor.

16. A composite structure as set forth in claim 1 wherein said first metal salt comprises cobalt carboxylate.

17. A composite structure as set forth in claim 1 wherein said peroxide-based catalyst comprises benzoyl peroxide.

18. A composite structure as set forth in claim 17 wherein said catalyst system further comprises an accelerator selected from the group of anilines, amines, amides, pyridines, and combinations thereof.

19. A composite structure as set forth in claim 1 wherein said peroxide-based catalyst comprises cumene hydroperoxide.

20. A composite structure as set forth in claim 1 wherein said catalyst system further comprises a second metal salt comprising potassium octoate.

21. A composite structure as set forth in claim 1 wherein said catalyst system further comprises an accelerator selected from the group of anilines, amines, amides, pyridines, and combinations thereof.

22. A composite structure as set forth in claim 1 wherein said isocyanate-reactive functional group is selected from the group of hydroxy-functional groups, amine-functional groups, and combinations thereof.

23. A composite structure as set forth in claim 1 wherein said isocyanate-reactive functional group has an alkyl portion with from one to twenty carbon atoms and said functionalized acrylate component has at least one alkyl group with from one to twenty carbon atoms.

24. A composite structure as set forth in claim 1 wherein said stoichiometric excess of said functionalized acrylate component comprises a molar equivalent ratio of said functionalized acrylate component to said isocyanate component ranging from 3:1 to 1.05:1.

25. A composite structure as set forth in claim 24 wherein said molar equivalent ratio of said functionalized acrylate component to said isocyanate component ranges from 2.5:1 to 1.05:1.

26. A composite structure as set forth in claim 1 wherein said fiber is selected from the group of fiberglass, carbon fibers, wood fibers, aramid fibers, polymer fibers, and combinations thereof.

27. A composite structure as set forth in claim 1 wherein said urethane acrylate layer further comprises at least one additive selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, and combinations thereof.

28. A composite structure as set forth in claim 1 wherein said support layer has a thickness of from 0.125 to 1 inches.

29. A composite structure as set forth in claim 1 wherein said urethane acrylate layer has a thickness of from 0.005 to 0.05 inches.

30. A composite structure as set forth in claim 1 wherein said composite structure is a tonneau cover for a vehicle.

31. A composite structure comprising:
A) a urethane acrylate layer comprising a urethane acrylate composition comprising a urethane acrylate adduct comprising the reaction product of:
I) an isocyanate component having at least two isocyanate groups; and
II) a stoichiometric excess of a functionalized acrylate component having at least one isocyanate-reactive functional group; and
B) a support layer spaced from said first layer and comprising:
I) a second urethane acrylate composition; and
II) a fiber.

32. A composite structure as set forth in claim 31 wherein said isocyanate component comprises an aliphatic isocyanate.

33. A composite structure as set forth in claim 32 wherein said aliphatic isocyanate is selected from the group of hexamethylene diisocyanate, hexamethylene diisocyanate trimer, hexamethylene diisocyanate biuret, cyclohexane diisocyanate, isophorone diisocyanate, isophorone diisocyanate trimer, dicyclohexane-4,4′diisocyanate, meta-tetramethylxylene diisocyanate, and combinations thereof.

34. A composite structure as set forth in claim 31 wherein said isocyanate component comprises an aromatic isocyanate.

35. A composite structure as set forth in claim 34 wherein said aromatic isocyanate is selected from the group of toluene diisocyanates, polymeric diphenylmethane diisocyanates, diphenylmethane diisocyanates, and combinations thereof.

36. A composite structure as set forth in claim 31 wherein said second urethane acrylate composition is the same as said urethane acrylate composition.

37. A composite structure as set forth in claim 31 wherein said second urethane acrylate composition comprises a second urethane acrylate adduct comprising the reaction product of a second isocyanate component different from said isocyanate component and a second functionalized acrylate component.

38. A composite structure as set forth in claim 37 wherein said second isocyanate component comprises an aromatic isocyanate selected from the group of toluene diisocyanates, polymeric diphenylmethane diisocyanates, diphenylmethane diisocyanates, and combinations thereof.

39. A composite structure as set forth in claim 31 further comprising a first layer that is a show surface of said composite structure.

40. A composite structure as set forth in claim 39 wherein said first layer comprises a paint selected from the group of latex-based waterborne paints, latex-based solventborne paints, acrylic-based waterborne paints, acrylic-based solventborne paints, polyurethane-based waterborne paints, polyurethane-based solventborne paints, and combinations thereof.

41. A composite structure as set forth in claim 39 wherein said support layer is spaced from said first layer.

42. A composite structure as set forth in claim 41 wherein said urethane acrylate layer is disposed between said support layer and said first layer.

43. A composite structure as set forth in claim 31 wherein said urethane acrylate composition further comprises a catalyst system comprising a peroxide-based catalyst, a first metal salt comprising cobalt carboxylate, a second metal salt comprising potassium octoate, and an accelerator selected from the group of anilines, amines, amides, pyridines, and combinations thereof.

44. A composite structure as set forth in claim 43 wherein said peroxide-based catalyst comprises benzoyl peroxide.

45. A composite structure as set forth in claim 44 wherein said accelerator is selected from the group of anilines, amines, amides, pyridines, and combinations thereof.

46. A composite structure as set forth in claim 43 wherein said peroxide-based catalyst comprises cumene hydroperoxide.

47. A composite structure as set forth in claim 31 wherein said functional group is selected from the group of hydroxy-functional groups, amine-functional groups, and combinations thereof.

48. A composite structure as set forth in claim 31 wherein said isocyanate-reactive functional group has an alkyl portion with from one to twenty carbon atoms and said functionalized acrylate component has at least one alkyl group with from one to twenty carbon atoms.

49. A composite structure as set forth in claim 31 wherein said stoichiometric excess of said functionalized acrylate component comprises a molar equivalent ratio of said functionalized acrylate component to said isocyanate component ranging from 3:1 to 1.05:1.

50. A composite structure as set forth in claim 49 wherein said molar equivalent ratio of said functionalized acrylate component to said isocyanate component ranges from 2.5:1 to 1.05:1.

51. A composite structure as set forth in claim 31 wherein said fiber is selected from the group of fiberglass, carbon fibers, wood fibers, aramid fibers, polymer fibers, and combinations thereof.

52. A composite structure as set forth in claim 31 wherein said urethane acrylate layer and said support layer further comprise at least one additive selected from the group of surfactants, plasticizers, polymerization inhibitors, antioxidants, compatibilizing agents, supplemental cross-linking agents, flame retardants, anti-foam agents, UV performance enhancers, hindered amine light stabilizers, pigments, thixotropic agents, reactive fillers, non-reactive fillers, and combinations thereof.

53. A composite structure as set forth in claim 31 wherein said support layer has a thickness of from 0.125 to 1 inches.

54. A composite structure as set forth in claim 31 wherein said urethane acrylate layer has a thickness of from 0.01 to 0.04 inches.

55. A composite structure as set forth in claim 31 wherein said composite structure is a tonneau cover for a vehicle.
